(19) United States
(12) Patent Application Publication
(10) Pub. No.: US 2022/0222600 A1
(43) Pub. Date: Jul. 14, 2022

(54) USER AUTHENTICATION AND PERSONALIZATION WITHOUT USER CREDENTIALS

(71) Applicant: GM Cruise Holdings LLC, San Francisco, CA (US)

(72) Inventors: Stephanie Olivia Engle, San Francisco, CA (US); Jessica Leary, San Francisco, CA (US); Soleil Phan, San Francisco, CA (US)

(21) Appl. No.: 17/708,684

(22) Filed: Mar. 30, 2022

Related U.S. Application Data
(63) Continuation of application No. 16/588,906, filed on Sep. 30, 2019.

(51) Int. Cl. G06Q 10/06

(52) U.S. Cl. CPC G06Q 10/06311

(57) ABSTRACT

A system having a computing system having at least one processor and at least one memory. The memory may have instructions thereon that cause the at least one processor to receive from a vehicle, data recorded by a sensor of the vehicle regarding attributes associated with an unknown passenger who has engaged in at least a portion of a trip with the vehicle and match the recorded attributes of the unknown passenger to a profile of a known passenger profile in a database of passenger profiles.

### CROSS-REFERENCE TO RELATED APPLICATIONS

This application is a continuation of U.S. application Ser. No. 16/588,906, filed on Sep. 30, 2019, entitled, USER AUTHENTICATION AND PERSONALIZATION WITHOUT USER CREDENTIALS, which is hereby expressly incorporated by reference in its entirety and for all purposes.

### TECHNICAL FIELD

The present technology relates to a system and method to authenticate and personalize a ride experience for a user and more particularly without user credentials.

### BACKGROUND

An autonomous vehicle is a motorized vehicle that can navigate without a human driver. An exemplary autonomous vehicle includes a plurality of sensor systems, such as, but not limited to, a camera sensor system, a lidar sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

When a vehicle is used for ridesharing purposes, the vehicle is shared with and comes into contact with many different people with different roles, such as known or identified passengers and unknown or unidentified passengers. Human drivers use their judgment to determine how to personalize and communicate with the passenger. However, autonomous vehicles lack a human driver; thus, it is challenging for the autonomous vehicle to communicate with and personalize itself to cater to preferences of the known and/or unknown passenger.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of an example system for operating an autonomous vehicle in accordance with some aspects of the present technology;

FIG. 2 is a flow diagram that illustrates an example process for authenticating and personalizing a ride for a passenger;

FIG. 3 is a flow diagram that illustrates an example algorithm for matching unknown passengers with known passenger profiles; and

FIG. 4 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

In general, it is challenging to identify passengers unless the passenger directly provides personally identifying information, such as account credentials. In traditional vehicles with human drivers, the human drivers may communicate with and use their judgment to determine how to satisfy and personalize a ride experience for the passengers. An autonomous vehicle lacks a human driver, so it is even more challenging for the autonomous vehicle to determine how to satisfy and/or personalize the ride experience for the passengers.

Even with the use of traditional account credentials, the passenger may be unwilling and/or unable to create and/or provide account credentials. For example, some passengers may believe that account credentials are vulnerable to security issues, elicit privacy and/or misuse concerns, etc. Thus, these passengers may be unwilling to create and/or provide account credentials. Furthermore, these account credentials are directly tied to the account holder; thus when passengers have guest passengers, the autonomous vehicle is unable to tailor the ride experience to these guest passengers. Similarly, some passengers may want to hail an autonomous vehicle as they would a taxi. These passengers may also be first time passengers of the autonomous vehicle, so they would not have account credentials. Thus, the autonomous vehicle again would not be able to personalize the ride experience for these passengers.

Moreover, some passengers may purposefully evade creating account credentials because they may be prevented or screened from use (i.e. banned because of misuse). Because of the lack of account credentials, the autonomous vehicle is unable to determine that the passenger is one for which the autonomous vehicle should deny service.

Furthermore, even with passengers who provide account credentials, it is challenging to properly authenticate that the passenger providing the account credentials is the owner of the account credentials.

Thus, the disclosed technology addresses the need in the art for a system and/or method for determining and authenticating passengers without account credentials.

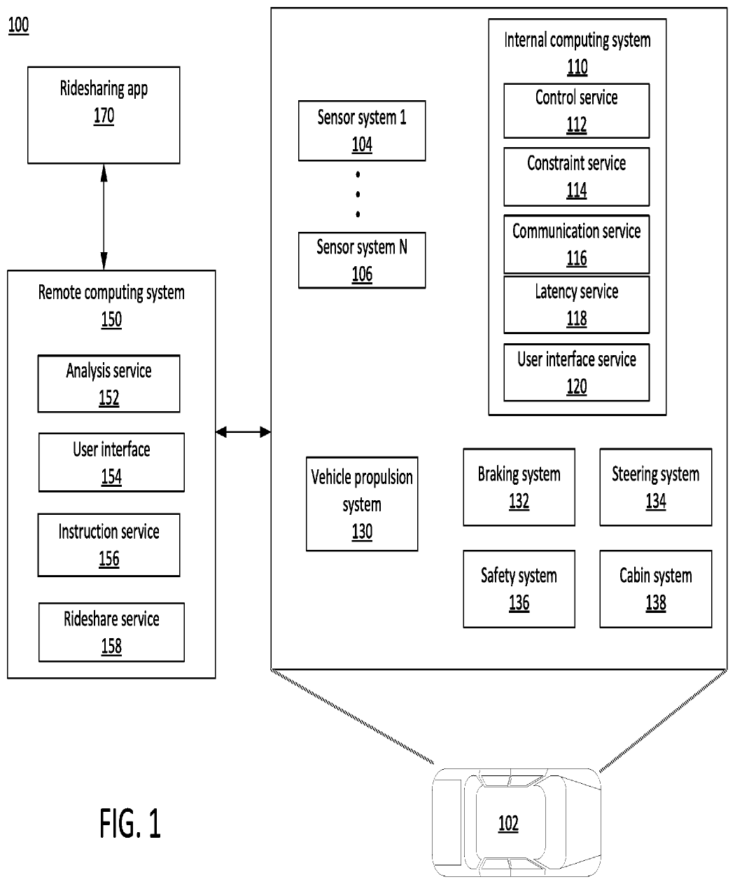

FIG. 1 illustrates environment 100 that includes an autonomous vehicle 102 in communication with a remote computing system 150.

The autonomous vehicle 102 can navigate about roadways without a human driver based upon sensor signals output by sensor systems 104-106 of the autonomous vehicle 102. The autonomous vehicle 102 includes a plurality of sensor systems 104-106 (a first sensor system 104 through an Nth sensor system 106). The sensor systems 104-106 are of different types and are arranged about the autonomous vehicle 102. For example, the first sensor system 104 may be a camera sensor system, and the Nth sensor system 106 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 104-106 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 104-106 and human co-pilots, etc.

The internal computing system 110 can include a control service 112 that is configured to control the operation of the vehicle propulsion system 106, the braking system 108, the steering system 110, the safety system 136, and the cabin system 138. The control service 112 receives sensor signals from the sensor systems 104-106 as well communicates with other services of the internal computing system 110 to effectuate operation of the autonomous vehicle 102. In some embodiments, control service 112 may carry out operations in concert one or more other systems of autonomous vehicle 102.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing application 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

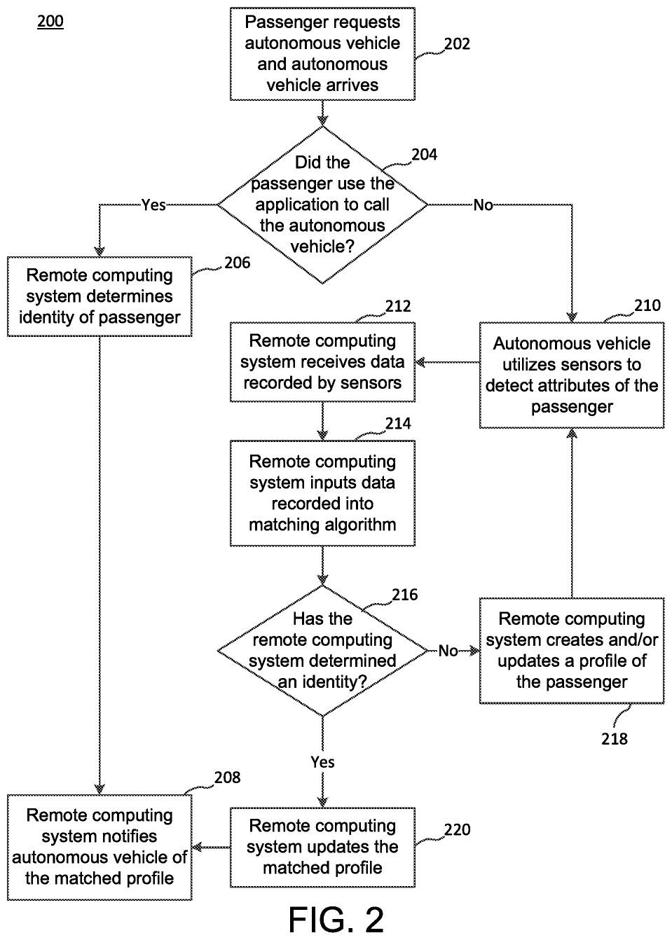

FIG. 2 is a flow diagram that illustrates a process 200 for authenticating and personalizing a ride for a passenger.

The process 200 begins at step 202, when a passenger requests the autonomous vehicle 102. The request may occur in a plurality of different ways, including but not limited to through the ridesharing application 170, physical hailing of the autonomous vehicle 102, waiting in a queue for autonomous vehicles 102, etc. The autonomous vehicle 102 receives the request, responds to the request, and arrives at the requested location.

At step 204, the autonomous vehicle 102 determines how the passenger requested or called the autonomous vehicle 102. In some embodiments, the request may have data containing how the request was made (e.g. through the ridesharing application 170). If the autonomous vehicle determines that the passenger used the ridesharing application 170 to request the autonomous vehicle 102, the process 200 continues to step 206. If the autonomous vehicle 102 determines that the passenger did not use the ridesharing application 170 to request the autonomous vehicle 102, the process 200 continues to step 210. For example, the remote computing system 150 may receive a ride hailing communication from the autonomous vehicle 102 that identifies the autonomous vehicle 102 having a status as being hailed for a trip or ride by physical actions of an unknown passenger. In some embodiments, the action of hailing the autonomous vehicle 102 may constitute engaging in at least a portion of the trip or ride.

At step 206, the remote computing system 150 determines an identity or an identification of the passenger (e.g. an identification of a user profile from a user device of the passenger). In some embodiments, the request may also have data containing the identity of the passenger. Furthermore, in some embodiments, the remote computing system 150 may combine the passenger profile with the user profile to generate a combined profile.

At step 208, the remote computing system 150 notifies the autonomous vehicle 102 of the user profile, passenger profile, and/or combined profile. The user profile, passenger profile, and/or combined profile may contain information and preferences of the passenger, so that the autonomous vehicle 102 may personalize the ride experience according to the information and preferences of the passenger.

Referring back to step 210, the autonomous vehicle 102 utilizes the sensor systems 104-106 to detect attributes of the passenger, which may currently be an unknown passenger. The attributes may include height, weight, approach speed to the autonomous vehicle 102, typical actions or habits, preferences, biometric data, facial attributes, etc. The detected attributes are then recorded as data. In some embodiments, the attributes may be detected prior to the unknown passenger entering the autonomous vehicle 102. For example, aspects of the action of hailing the autonomous vehicle 102 may constitute attributes associated with the unknown passenger.

At step 212, the autonomous vehicle 102 sends the recorded data to the remote computing system 150. The remote computing system 150 then receives the data recorded by the sensor systems 104-106. In some embodiments, the sending and receipt of the data recorded by the sensor systems 104-106 of the autonomous vehicle 102 regarding attributes associated with the unknown passenger may occur prior to the unknown passenger entering the vehicle.

At step 214, the remote computing system 150 then inputs the recorded data into a matching algorithm, service, or system (i.e. analysis service 152).

At step 216, using the matching algorithm or analysis service 152, the remote computing system 150 determines an identity of the passenger and/or whether the recorded data is similar to recorded data of previous profiles. The previous profiles may have data descriptive of attributes associated with previous rides and passengers. The analysis service 152 may then return a plurality of candidate passenger profiles that have data descriptive of attributes associated with the candidate passengers that match attributes associated with the passenger. In other words, the remote computing system 150 searches for candidate passenger profiles that are potential matches, such that the candidate passenger profiles have similar and/or matching attributes as the attributes of the passenger currently requesting the autonomous vehicle 102.

Without enough attributes, the remote computing system 150 may determine and/or receive a large number of profiles that have similar attributes. Thus, the remote computing system 150 may determine that there is not a good match and cannot conclusively determine that the current passenger is the same passenger as the passenger of the candidate passenger profiles. In other words, the remote computing system 150 determines there is not a match and/or an inconclusive match, so the remote computing system 150 has not determined the identity of the passenger and the process moves to step 218.

At step 218, the remote computing system 150 creates and/or updates a profile of the passenger. The profile may include the data recorded by the sensor systems 104-106 that was used in the matching algorithm. More specifically, the remote computing system 150 creates and/or updates an unmatched profile with the attributes associated with the passenger. The process then returns to step 210, where the autonomous vehicle 102 utilizes the sensor systems 104-106 to detect attributes of the passenger.

Referring back to step 216, with enough attributes, the remote computing system 150 may sufficiently narrow the number of candidate passenger profiles to a single profile. Thus, the remote computing system 150 may then receive and/or determine that the profile of the passenger currently requesting the autonomous vehicle 102 matches the single profile of a passenger who has previously been in an autonomous vehicle 102. In other words, the remote computing system 150 may then determine that the current passenger is the same passenger as the passenger of the matching profile. Thus, the remote computing system 150 may determine the identity of the passenger, such that the previously unknown passenger is now a known passenger and the process continues to step 220.

In some scenarios, the passenger may be a first time passenger, not having a profile. Accordingly, the passenger will not match with any of the candidate profiles and the remote computing system 150 may eliminate all candidate profiles. When the remote computing system 150 eliminates all candidate profiles, the remote computing system 150 may determine that the identity of the passenger is that of a new passenger and/or there is insufficient data to pair the passenger with any other candidate passenger profiles. Despite identification of a specific identity, the unknown passenger is now a known passenger in that the remote computing system 150 can identify the passenger as a new passenger. Thus, the process may still continue to step 220.

At step 220, the remote computing system 150 updates the passenger profile with the matching candidate profile to generate a known passenger profile. The known passenger profile may then have additional attributes from the ride that the passenger has most recently requested.

In some embodiments, when the remote computing system 150 has utilized the matching algorithm to identify, generate, and/or update a threshold number of unmatched profiles in a collection of unmatched profiles, the remote computing system 150 may identify and/or determine that the unmatched profiles match other unmatched profiles. Accordingly, the remote computing system 150 may then create a second known passenger profile in the database of passenger profiles from a collection of unmatched profiles, which belong to the same passenger.

At step 208, the remote computing system 150 sends the known passenger profile so that the autonomous vehicle 102 can tailor the ride experience to preferences and needs of the passenger. In other words, the remote computing system 150 sends information of the now known passenger profile to the autonomous vehicle 102, whereby the autonomous vehicle 102 can customize itself in accordance with the preferences and needs in the known passenger profile.

In some embodiments, the autonomous vehicle 102 may continue utilizing the sensor systems 104-106 to detect attributes after detecting the identity of the passenger. The detected attributes may still be recorded as data to be sent to the remote computing system 150, so that the remote computing system 150 may continue updating the known passenger profile. Thus, the continuous attribute detection and data recording may continuously provide more information for the remote computing system 150 to add to the known passenger profile. Accordingly, the autonomous vehicle 102 may then have more information to further customize or personalize the ride experience for the known passenger.

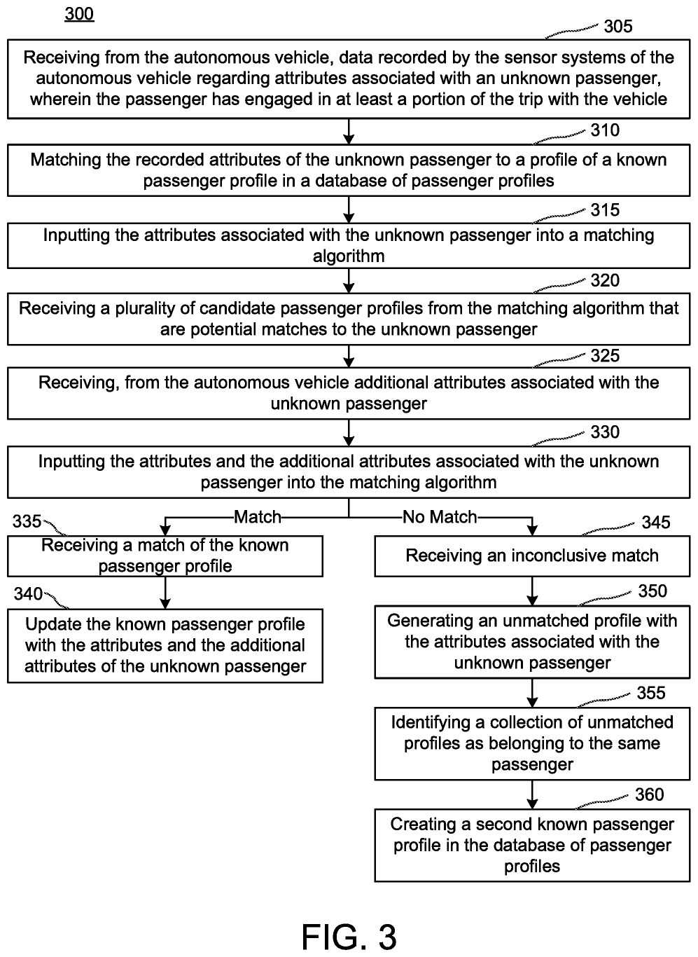

FIG. 3 shows an example of a matching algorithm 300 that may be used by the remote computing server 150 above.

At step 305, the matching algorithm 300 may begin when the remote computing system 150 receives from the autonomous vehicle 102, data recorded by the sensor system 104-106 of the autonomous vehicle 102 regarding attributes associated with an unknown passenger. The passenger may have engaged in at least a portion of a trip with the vehicle.

At step 310, the remote computing system 150 attempts to match the recorded attributes of the unknown passenger to a profile of a known passenger profile in a database of passenger profiles.

More specifically, at step 315, attributes associated with the unknown passenger are inputted into the remote computing system 150.

At step 320, the remote computing system 150 may determine, based upon the attributes of the unknown passenger and attributes of known passengers, a plurality of candidate passenger profiles that are potential matches to the unknown passenger.

At step 325, the remote computing system 150 may receive from the autonomous vehicle 102 additional attributes associated with the unknown passenger. More specifically, in some embodiments, the autonomous vehicle 102 may detect the additional attributes after some time has elapsed. In some embodiments, the remote computing system 150 may have requested additional attributes to assist in narrowing down the plurality of candidate passenger profiles. For example, if the remote computing system 150 narrows down potential matches to two candidate profiles, the remote computing system 150 can specifically request distinctive characteristics that would differentiate the two profiles (e.g. one person may have blue eyes and the other may have brown eyes). The additional attributes may be attributes as defined above that were not originally detected, may not have had enough data for a conclusive machine learning matching, etc.

At step 330, the attributes and the additional attributes associated with the unknown passenger are inputted into the remote computing system 150.

At step 335, the matching algorithm 300 determines and/or receives a match of the known passenger profile.

At step 340, the matching algorithm 300 then updates the known passenger profile with the attributes and the additional attributes of the unknown passenger because the matching algorithm has determined that the unknown passenger matches the known passenger profile.

Referring back to step 330 and onwards to step 345, the matching algorithm 300 may receive an inconclusive match. The inconclusive match may be a result of insufficient attributes to determine whether the unknown passenger matches any known passenger profiles. The inconclusive match may also be a result of incompatibility between the attributes of the unknown passenger and the attributes of the known passenger profiles.

At step 350, the matching algorithm 300 generates an unmatched profile with the attributes associated with the unknown profile.

At step 355, the matching algorithm 300 may identify a collection of unmatched profiles as belonging to the same passenger.

At step 360, the matching algorithm 300 may create a second known passenger profile in the database of passenger profiles from the collection of unmatched profiles that belong to the same passenger.

In some embodiments, the algorithm may be implemented through machine learning. For example, the algorithm may be trained by identifying attributes that are associated between different rides of the same passenger. Furthermore, the algorithm may be further trained by identifying attributes that are not associated to the same passenger so that the algorithm understands that the attributes not associated with the same passenger belongs to another passenger. Similarly, the algorithm may be trained to identify commonalities among multiple passengers and create or update a ranking of how important the attributes may be, based upon the commonalities, the frequency of the attribute and/or the importance of the attribute itself. For example, the algorithm may determine that having a left dominant hand is an important attribute to determine an identity of the passenger and is accordingly ranked above a passenger's preference to sit on the right side of the autonomous vehicle 102.

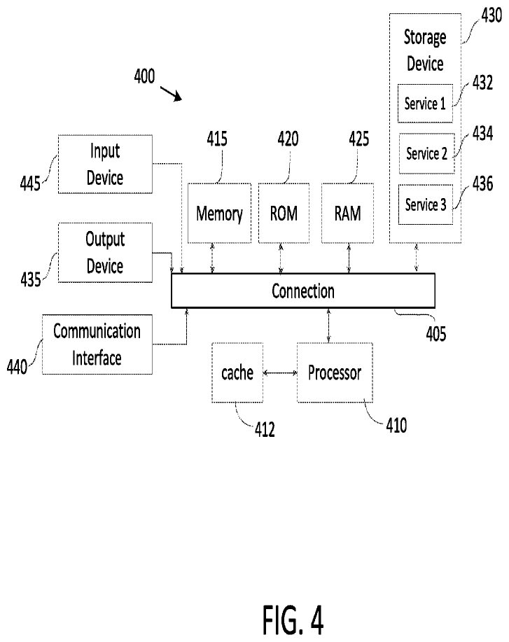

FIG. 4 shows an example of computing system 400, which can be for example any computing device making up internal computing system 110, remote computing system 150, (potential) passenger device executing rideshare app 170, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed:

1. A computer-implemented method comprising:
receiving a ride hailing communication from a vehicle that identifies a status of the vehicle as being hailed for a trip by an unknown passenger;
receiving from the vehicle, image data recorded by a camera sensor of the vehicle regarding attributes associated with the unknown passenger, and wherein aspects of hailing the vehicle constitute attributes associated with the unknown passenger; and
attempting to match the recorded attributes of the unknown passenger in the image data to a known passenger profile.

2. The computer-implemented method of claim 1, wherein the ride hailing communication includes physical actions by the unknown passenger.

3. The computer-implemented method of claim 1, wherein an action of hailing the vehicle constitutes at least a portion of the trip.

4. The computer-implemented method of claim 1, further comprising:
sending information in the known passenger profile to the vehicle, whereby the vehicle can customize itself to preferences in the known passenger profile.

5. The computer-implemented method of claim 1, wherein the attributes associated with the unknown passenger are received prior to the unknown passenger entering the vehicle.

6. The computer-implemented method of claim 1, wherein attempting to match the recorded attributes of the unknown passenger in the image data to the known passenger profile includes:
determining that the unknown passenger is a new passenger; and
generating a second passenger profile with the attributes associated with the unknown passenger.

7. The computer-implemented method of claim 1, further comprising:
utilizing a matching algorithm to identify a collection of unmatched profiles as belonging to a same passenger; and
creating a second passenger profile in the database of passenger profiles from the collection of unmatched profiles belonging to the same passenger.

8. A system comprising:
a storage configured to store instructions; and
a processor configured to execute the instructions and cause the processor to:
receive a ride hailing communication from a vehicle that identifies a status of the vehicle as being hailed for a trip by an unknown passenger;
receive from the vehicle, image data recorded by a camera sensor of the vehicle regarding attributes associated with the unknown passenger, and wherein aspects of hailing the vehicle constitute attributes associated with the unknown passenger; and
attempt to match the recorded attributes of the unknown passenger in the image data to a known passenger profile.

9. The system of claim 8, wherein the ride hailing communication includes physical actions by the unknown passenger.

10. The system of claim 8, wherein an action of hailing the vehicle constitutes at least a portion of the trip.

11. The system of claim 8, wherein the processor is configured to execute the instructions and cause the processor to:
send information in the known passenger profile to the vehicle, whereby the vehicle can customize itself to preferences in the known passenger profile.

12. The system of claim 8, wherein the attributes associated with the unknown passenger are received prior to the unknown passenger entering the vehicle.

13. The system of claim 8, wherein attempting to match the recorded attributes of the unknown passenger in the image data to the known passenger profile includes:
determining that the unknown passenger is a new passenger; and
generating a second passenger profile with the attributes associated with the unknown passenger.

14. The system of claim 8, wherein the processor is configured to execute the instructions and cause the processor to:
utilize a matching algorithm to identify a collection of unmatched profiles as belonging to a same passenger; and
create a second passenger profile in the database of passenger profiles from the collection of unmatched profiles belonging to the same passenger.

15. A non-transitory computer-readable medium comprising instructions, the instructions, when executed by a computing system, cause the system to:
receiving a ride hailing communication from a vehicle that identifies a status of the vehicle as being hailed for a trip by an unknown passenger;
receiving from the vehicle, image data recorded by a camera sensor of the vehicle regarding attributes associated with the unknown passenger, and wherein aspects of hailing the vehicle constitute attributes associated with the unknown passenger; and
attempting to match the recorded attributes of the unknown passenger in the image data to a known passenger profile.

16. The non-transitory computer-readable medium of claim 15, wherein the ride hailing communication includes physical actions by the unknown passenger.

17. The non-transitory computer-readable medium of claim 15, wherein an action of hailing the vehicle constitutes at least a portion of the trip.

18. The non-transitory computer-readable medium of claim 15, further comprising:
sending information in the known passenger profile to the vehicle, whereby the vehicle can customize itself to preferences in the known passenger profile.

19. The non-transitory computer-readable medium of claim 15, wherein the attributes associated with the unknown passenger are received prior to the unknown passenger entering the vehicle.

20. The non-transitory computer-readable medium of claim 15, wherein attempting to match the recorded attributes of the unknown passenger in the image data to the known passenger profile includes:
determining that the unknown passenger is a new passenger; and
generating a second passenger profile with the attributes associated with the unknown passenger.
